(19) United States
(12) Patent Application Publication
(10) Pub. No.: US 2001/0040550 A1
(43) Pub. Date: Nov. 15, 2001

(54) MULTIPLE PRESSURE SENSORS PER FINGER OF GLOVE FOR VIRTUAL FULL TYPING

(76) Inventors: SCOTT VANCE, STANFORD, CA (US); LARISA MIGACHYOV, STANFORD, CA (US); WAYNE HON FU, STANFORD, CA (US); IRA E. HAJJAR, SAN JOSE, CA (US); JASON TRAVIS GRANT, PALO ALTO, CA (US)

Correspondence Address: US PHILIPS CORPORATION, CORPORATE PATENT COUNSEL, 580 WHITE PLAINS RD, TARRYTOWN, NY, 10591

(21) Appl. No.: 09/251,682

(22) Filed: Feb. 17, 1999

Related U.S. Application Data
(60) Provisional application No. 60/077,744, filed on Mar. 12, 1998.

(51) Int. Cl. G09G 5/00

(52) U.S. Cl. 345/156

(57) ABSTRACT

A glove has an array of pressure sensors mounted longitudinally at the finger-tips. When touching a rigid surface with the glove, different sensors are being activated dependent on the orientation of the finger tip relative to the surface. This configuration enables interacting with a virtual keyboard having multiple rows of keys.

### FIELD OF THE INVENTION

The invention relates to a system for processing information comprising an apparatus for manually controlling information input.

### BACKGROUND ART

Such a system is known from U.S. Pat. No. 5,581,484, incorporated herein by reference. The known system has a finger-mounted input device for manually entering information into a computer. The device uses a pressure sensor and a pair of acceleration sensors removably attached to the finger tip of a user. The pressure sensor senses a pressure when the finger presses against an object, e.g., a table surface. The acceleration sensors measure the acceleration of the finger. The sensors are mounted in a flexible glove. The signals of the sensors are relayed to a computer that calculates the relative position of the finger. Twice integrating an acceleration measured gives a coordinate of the current position of the finger relative to a begin position. The pressure sensor is used to validate the signal of the acceleration sensors. The known system allows a user to enter data into the system as if he or she were typing on a physical keyboard, such as the standard QWERTY keyboard.

The use of acceleration to measure a position requires integrating twice, and the accumulation of offset or inaccuracy in the acceleration measured may dramatically affect the calculated position. Compensation methods include, for example, using threshold values for the signals supplied by the acceleration sensors, using a feedback control sub-system, or frequently resetting the finger to a reference position. These compensation methods put an additional burden on the user, on the system or on both.

### OBJECT OF THE INVENTION

It is an object of the invention to provide a more user-friendly alternative to the known system.

### SUMMARY OF THE INVENTION

To this end, the invention provides a system for processing information. The system comprises a device that is mountable to a finger of a user and that has a sensing sub-system. The sub-system discriminates between stimuli, e.g., pressures, sensed in different locations on the device, and generates a respective signal corresponding to a respective one of the locations.

The invention is based on the insight that when a user interacts with a keyboard (e.g., a QWERTY keyboard, a keyboard of a music instrument or a specific keyboard that controls another specific apparatus) the angle at which the finger contacts the key depends on the row to which a key belongs. The different orientations of the finger are being used in the invention to distinguish between virtual keys of different rows. A sensing sub-system is mounted on the user's finger and discriminates between the different finger orientations that map onto positions of keys in different rows. For example, the invention has an array of contact sensors that are activated dependent on the finger's orientation when contacting with a more or less rigid surface. A contact sensor comprises, e.g., a pressure-activated switch, or a conductive area that establishes an electric connection with a conductive surface, etc.

The inventors also have recognized that a specific finger may control more than one column of keys. For example, interacting with a QWERTY-keyboard using ten-finger typing typically lets the index finger and the small finger each control two or more columns. Preferably, a lateral selection mechanism is added to the longitudinal selection mentioned above in order to distinguish between abduction and adduction of the finger. For example, a magnetic reed switch is mounted on the index finger and a magnet on the neighboring finger. Alternatively, a strain gauge is mounted in the portion between the index and middle finger. This portion is susceptible to stretching when the lateral distance between these fingers increases. A variety of sensing mechanisms, both for the longitudinal and lateral orientations is feasible, based on sensing a magnitude of a particular quantity or a change in a physical quantity, e.g., distance or proximity, angle, moment of force, etc. The pink of the right hand is typically used to control three or more columns. In order to discriminate between more than two columns, the lateral selection mechanism comprises, for example, multiple sensors with different sensitivity ranges.

Discrimination based on the position of the stimulus can also be used to simulate interaction with a trackball or mouse. For example, the sliding of the sensing sub-system across a solid underground in a longitudinal direction lets different locations of the sub-system contact the underground. A timer determines that the time period of contact is longer than is typically required for typing. The signal generated is then interpreted as manipulating a virtual mouse or trackball in one direction. Similarly, detection of a lateral movement of the index, based on a transition from adduction to abduction, or vice versa, combined with a timer or with a continuous stimulus occurring at the fingertip, can be used to interpret a sideways mouse movement or trackball movement.

The device, which is mountable to the user's finger, may comprise, e.g., a thimble-shaped implement, or a glove with appropriately mounted sensors per finger, or any other configuration that is suitable within the context of the invention.

The device preferably also comprises visual indications as to the functionality or functionalities of the keys to be operated by the device. For example, a glove implementation of the invention for use with a virtual QWERTY keyboard has characters printed on a portion visible to the user (e.g., on the fingers of the glove or on the back of the hand near the base of each finger) so as to facilitate wielding the device properly.

A typical PC keyboard comprises more keys than the ones for a QWERTY functionality. For example, the PC-keyboard has a row of keys for the Arabic numerals 1, 2, . . . , 9, and 0, and a row of function keys. Accordingly, such a keyboard has five rows: three for QWERTY, one for the Arabic numerals, and one for the function keys. One way to discriminate between the rows is to have the sensing sub-system introduced above being capable of sensing in at least five different locations on the device, and of generating a respective signal corresponding to a respective one of the locations. Another way is to have a sensor mounted to the user's hand that changes the interpretation of the row being controlled when the sensor is activated. For example, the sensor is mounted to the palm of the hand and gets activated when the user presses down his/her palm. Thereupon, the signals from the sensing subsystem are interpreted as originating from the function keys or the Arabic numeral keys.

The invention is preferably used with a virtual desktop system as disclosed in U.S. patent application Ser. No. 08/887,593 (PHA 23,258), incorporated herein by reference.

### BRIEF DESCRIPTION OF THE DRAWINGS

The invention is explained by way of example and with reference to the accompanying drawings, wherein:

FIG. 1 is block diagram of a system in the invention;

FIGS. 2-3 illustrate different orientations of a typist's finger when striking keys in different rows;

FIGS. 4-5 give circuit diagrams for processing finger movement signals.

Throughout the figures, same reference numerals indicate similar or corresponding features.

### PREFERRED EMBODIMENTS

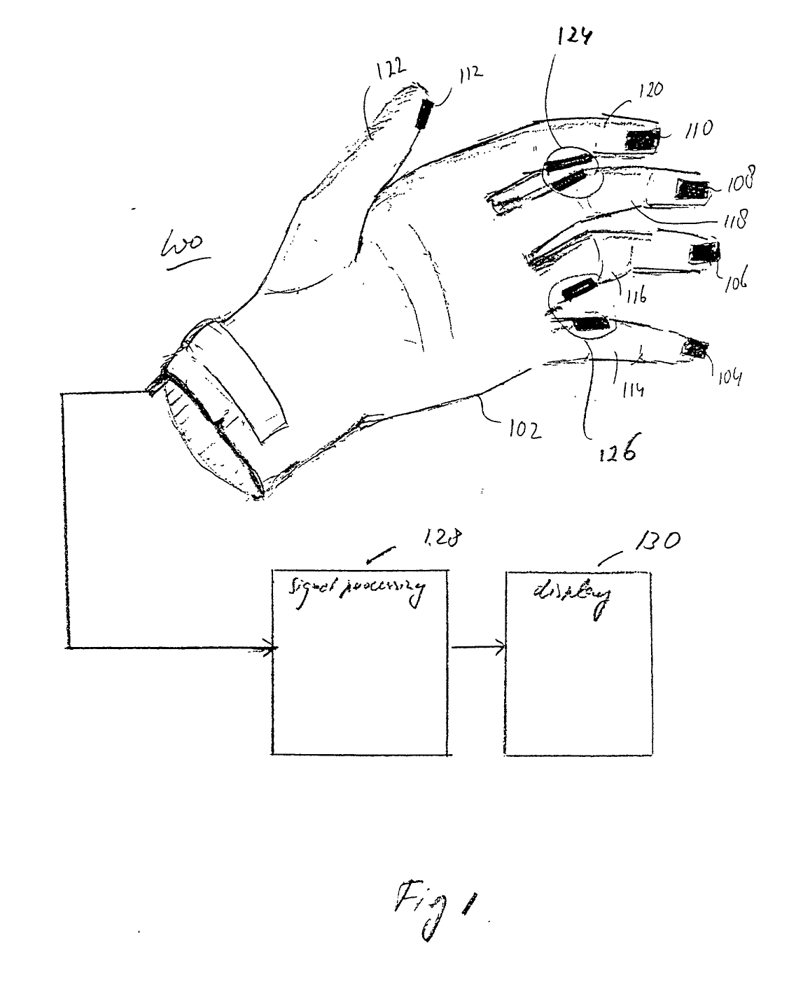

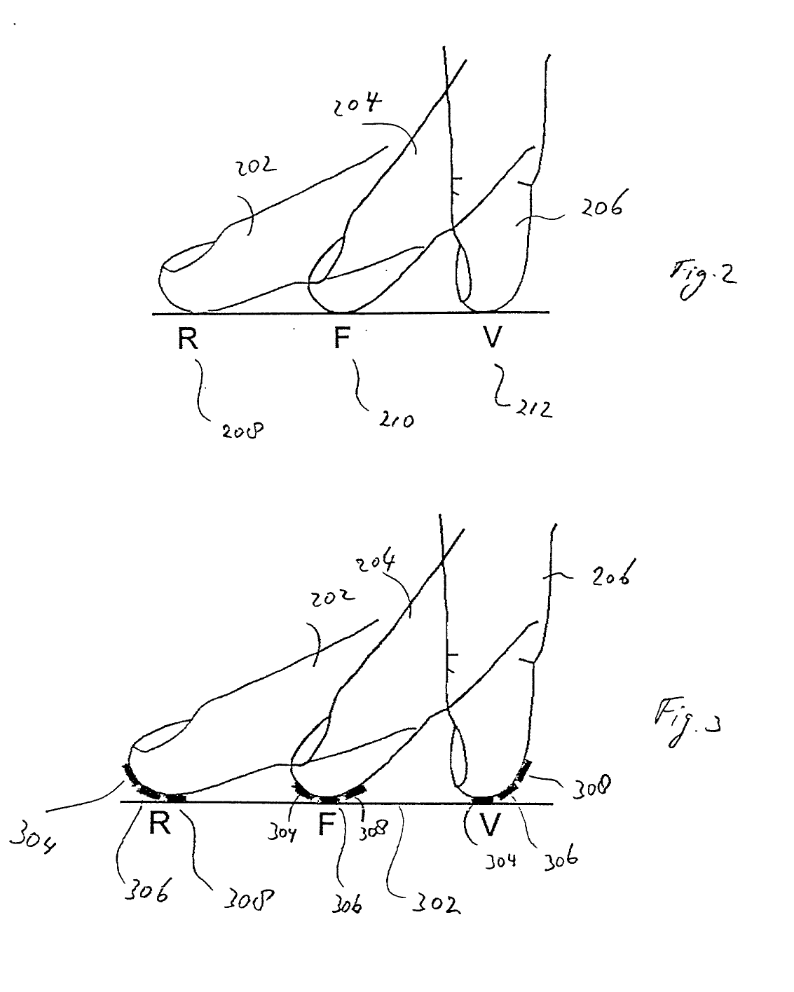

FIG. 1 is a block diagram with main components of a system 100 according to the invention. System 100 comprises an apparatus 102, here a glove, with devices 104, 106, 108, 110 and 112 mounted to fingers 114, 116, 118, 120 and a thumb 122, respectively. The user wears a pair of gloves for ten-finger typing, but FIG. 1 shows only left-hand glove 102 for clarity. The right-hand glove (not shown) is functionally similar to glove 102. Each of devices 104-110 has a respective first sensing sub-system (not shown here). Each of the subsystems discriminates between stimuli sensed at different locations at the corresponding one of devices 104-110. Each sub-system generates a specific signal corresponding to a stimulus sensed at a specific one of the locations. A specific sensitive location at a particular finger of glove 102 corresponds to a unique key of an alphanumeric keyboard. This is further explained below with reference to FIG. 2. In this example, device 112 at thumb 122 has a sensing sub-system that does not discriminate between locations where the stimulus is being applied. In ten-finger typing on a standard QWERTY-keyboard, the left-hand side and right-hand side thumbs are both used for the space bar, so that discrimination as to location is not required.

When typing with ten fingers, the index finger and the little finger typically control two columns each of keys of a QWERTY keyboard, whereas the other fingers control only one column of keys each, and the thumb controls the spacebar. Accordingly, second sensing sub-systems 124 and 126 are accommodated on glove 102 for sensing which of the two columns is controlled by the relevant finger. Sub-systems 124 and 126 sense whether the corresponding fingers are either abducted or adducted. This determines with which of the relevant columns the user is interacting. Sub-system 124 comprises, for example, a magnetic reed switch mounted on index finger 120 of glove 102 and a magnet mounted on the neighboring finger 118 to close or open the switch dependent on finger 120 being abducted or adducted. Sub-system 126 is functionally similar in this example. Other types of sensors can be used as alternatives to sense the abduction or adduction. For example, alternatives comprise optical proximity sensors with LEDs and light-sensitive material on neighboring fingers, or an arrangement of strain gauges near the roots of the fingers that supplies a signal discriminating between a small angle and a wider angle between the neighboring fingers, etc.

The signals generated by the pair of gloves are processed by a processing device 128 connected to a display 130. Device 128 receives the signals from the gloves and outputs signals that drive display 130 to display the alphanumeric characters corresponding with the stimulated locations. The routing of the signals from the gloves to device 128 can be done in a variety of ways, wired, e.g., electrically, optically, or wireless, e.g., via RF or IR, or acoustically. In the latter case, glove 102 has an on-board tone generator (not shown) to generate a particular acoustic signal, e.g., an audible “beep” or ultrasonic, representative of a particular virtual key when activated. Device 128 is operative to receive the acoustic signal and convert it to data for further processing. Independently this embodiment, an audible acoustic signal can be used to serve as an auditory feedback to the user in order to confirm a key's activation, either generated by device 128 or by the gloves themselves.

FIG. 2 illustrates the different orientations 202, 204 and 206 of a left index finger when typing on a real QWERTY keyboard. For example, the typist's left index finger controls keys 208, 210 and 212 for the letters “R”, “F”, and “V”, located in an upper row, a middle row and a lower row, respectively, of the keyboard. The finger strikes keys 208-212 at different angles as the user types letters in different rows of the keyboard.

FIG. 3 illustrates the mounting of sub-system 110 relative to the left index finger of the user when wearing glove 102 (not further shown here) in orientations 202, 204 and 206 explained with reference to FIG. 2. The location of contact between sub-system 110 and a plane 302 is different for each of orientations 202-206. In this example, sub-system 110 comprises an array of separate sensors 304, 306 and 308. Only a single one of sensors 304-308 is activated in a single one of orientations 202-206. Each of sensors 304-308 comprises, for example, a pressure sensor that closes an electrical switch when sensing a pressure level above a certain threshold. Preferably, sensors 304-308 provide both haptic feedback and auditory feedback, such as specific sensors sold by Digi-Key Corporation under part number P8006S-ND, or made by Panasonic as part EVQ-PAC04M.

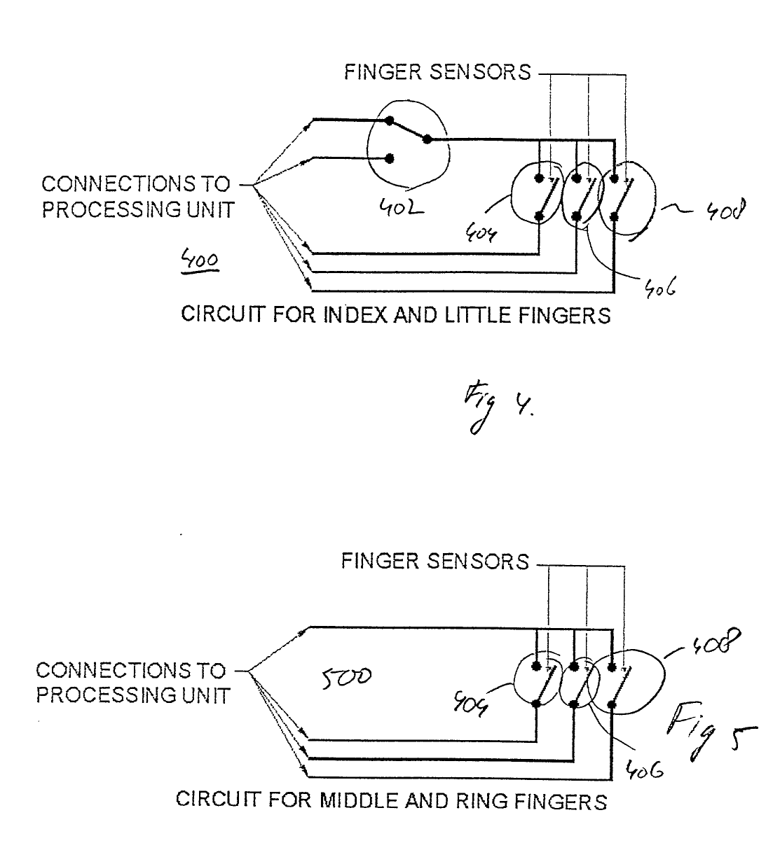

FIGS. 4 and 5 are diagrams of circuits 400 and 500 for an embodiment wherein sub-systems 104-112 comprise pressure sensors and sub-systems 124-126 comprise magnetic reed switches and magnets as mentioned above. Circuit 400 controls the information input via the index finger or the little finger. It comprises a switch 402 corresponding to sub-systems 124 or 126 that detect the abduction or adduction of the relevant finger, and switches 404, 406 and 408 that correspond to sensors 304, 306 and 308. Dependent on the orientation of the relevant finger when contacting surface 302 a specific one of switches 404-408 is closed. The state of switches 402-408 thus assumed is unique to a specific key on a virtual QWERTY keyboard. Sensing of the state, e.g., through a processing unit (not shown) in device 128 determines the intended key. Circuit 500 is simpler in that it lacks an abduction switch 402, and is used for input via the middle finger and ring finger.

We claim:

1. A system for processing information comprising an apparatus with at least one device that is mountable to a finger of a user and that has a sensing sub-system, wherein:
the sub-system is operative to discriminate between stimuli sensed at different locations at the device; and
the sub-system is operative to generate a specific signal corresponding to a stimulus sensed at a specific one of the locations.

2. The system of claim 1, wherein the information processing system comprises circuitry connected to the sub-system for receiving the specific signal and for mapping the specific signal onto a specific one of multiple virtual keys of a keyboard.

3. The system of claim 1, wherein the apparatus comprises at least one further device that is mountable to a further finger and that has a further sensing sub-system; wherein:
the further sub-system is operative to discriminate between stimuli sensed at different further locations at the further device; and
the further sub-system is operative to generate a specific further signal corresponding to a stimulus sensed at a specific one of the further locations.

4. The system of claim 1, wherein:
the apparatus comprises a respective device for mounting to a respective one of the user's fingers;
each respective device comprises a respective sensing sub-system;
the respective sub-system is operative to discriminate between stimuli sensed at different locations at the respective device; and
the respective sub-system is operative to generate a respective specific signal corresponding to a stimulus sensed at a specific one of the locations at the respective device.

5. The system of claim 1, wherein:
the apparatus comprises a sensor to sense an abducted or adducted position of the finger.

6. The system of claim 3, wherein the apparatus comprises a sensor to sense an abducted or adducted position of the further finger.

7. The system of claim 4, wherein the apparatus comprises at least one sensor to sense an abducted or adducted position of at least a single one of the fingers.

8. The system of claim 4, wherein:
the apparatus comprises another device for mounting to a thumb of the user;
the other device comprises another stimuli sensing sub-system; and
the other sensing sub-system senses a stimulus at a single location at the other device.

9. An apparatus for enabling manual user input into an information processing system, wherein:
the apparatus has at least one device that is mountable to a finger of a user;
the at least one device has an associated sensing sub-system;
the sub-system is operative to discriminate between stimuli sensed at different locations at the device; and
the sub-system is operative to generate a specific signal corresponding to a stimulus sensed at a specific one of the locations.

10. The apparatus of claim 9, wherein the associated sensing sub-system comprises an array of pressure sensors.

11. The apparatus of claim 9, comprising an abduction sensor to sense an abducted or adducted position of the finger.

12. The apparatus of claim 11, wherein the abduction sensor comprises a magnetic switch.

13. A method of interacting with a virtual keyboard, the method comprising:
manipulating an apparatus that has at least one device, wherein
the device has an associated sensing sub-system;
the sub-system is operative to discriminate between stimuli sensed at different locations at the device; and
the sub-system is operative to generate a specific signal corresponding to a stimulus sensed at a specific one of the locations;
the method further comprising:
touching a substantially rigid surface at the different locations.
